(19) United States
(12) Patent Application Publication
(10) Pub. No.: US 2012/0281803 A1
(43) Pub. Date: Nov. 8, 2012

(54) NEUTRON ABSORBING COMPOSITE FOR NUCLEAR REACTOR APPLICATIONS

(75) Inventors: David P. Reichwein, Central Hong Kong (HK); Keith A. Pocock, Shanghai (CN)

(73) Assignee: GIP International, LTD, Central Hong Kong (CN)

(21) Appl. No.: 13/464,226

(22) Filed: May 4, 2012

Related U.S. Application Data
(60) Provisional application No. 61/518,478, filed on May 7, 2011.

(51) Int. Cl. G21C 11/00

(52) U.S. Cl. 376/288; 376/287

(57) ABSTRACT

A multi-layered material composite is disclosed suitable for nuclear reactor applications to protect equipment from radiation damage. In one embodiment, the composite includes an internal neutron-absorbing layer and an external layer disposed on opposing sides of the internal layer. The external layers are made of metal or ceramic in various embodiments. The composite is disposed on or at least proximate to the an equipment component within the containment chamber of a nuclear reactor in some embodiments to protect the component from radiation damage.

### CROSS-REFERENCE TO RELATED APPLICATIONS

The present application claims the benefit of priority to U.S. Provisional Application No. 61/518,478 filed May 7, 2011, the contents of which is incorporated herein by reference in its entirety.

### FIELD

This invention relates to the safe operation of nuclear reactors, and more specifically to a means of providing protection against radiation within the nuclear reactor and its negative effects on equipment components located within a containment chamber.

### BACKGROUND

Protection against radiation within the containment chamber in a nuclear reactor facility is particularly important for components of the cooling water/steam circulation systems and other equipment such as components used for controlling movement of fuel and control rods. The containment chamber, typically concrete in construction, houses therein the metal reactor pressure vessel which includes a core of radioactive uranium-filled fuel rods and a metal shroud surrounding the core. A water-filled jacket is formed between the vertical walls of the shroud and pressure vessel which receives circulated water that is turned to steam. The foregoing construction is typical for a boiler water reactor (BWR). Recent safety issues have been raised concerning nuclear reactors due to effects of natural disasters and contamination of environmental areas outside a containment chamber.

### SUMMARY OF THE INVENTION

This invention provides a multi-layered composite to further protect facilities from accidental release of radiation to the environment and provides enhanced protection of equipment components in the facilities providing longer life without or minimizing radiation damage and reducing the time between shut down for repairs. More specifically, embodiments of the present invention provide a multi-layered composite comprising a layer including a neutron absorbing material that can be disposed on or at least proximate to the surface of the various equipment components including those located within a containment chamber. In some embodiments, the composite is conformable in configuration to the shape of the equipment component to be protected, or alternatively may have a non-conformal shape dimensioned to completely encapsulated the component where a conformal shape may not be practical.

According to one aspect of the present disclosure, a radiation absorbing system is provided for a nuclear reactor having a containment chamber and a reactor pressure vessel therein containing a fuel rod core. The system includes a multi-layer composite comprising an internal layer including a neutron absorbing material and an external layer disposed on opposing sides of the internal layer. The composite is disposed proximate or on the surface of an equipment component within the containment chamber of the nuclear reactor to protect the component from radiation damage. In one embodiment, the internal layer is comprised of boron.

### BRIEF DESCRIPTION OF THE DRAWINGS

The features of the embodiments will be described with reference to the following drawings where like elements are labeled similarly, and in which:

FIG. 1 is a cross-sectional view of one embodiment of a neutron absorbing composite according to the present disclosure;

FIG. 2 is a cross-sectional view of an alternative embodiment of a neutron absorbing composite; and

FIG. 3 is a cross-sectional view showing the neutron absorbing composite applied to an equipment component of a nuclear reactor.

All drawings are schematic and are not drawn to scale.

### DETAILED DESCRIPTION OF EMBODIMENTS

This description of illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation.

Terms such as “attached,” “affixed,” “coupled,” “connected” and “interconnected,” refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the embodiments. Accordingly, the disclosure expressly should not be limited to such embodiments illustrating some possible non-limiting combination of features that may exist alone or in other combinations of features; the scope of the disclosure being defined by the claims appended hereto.

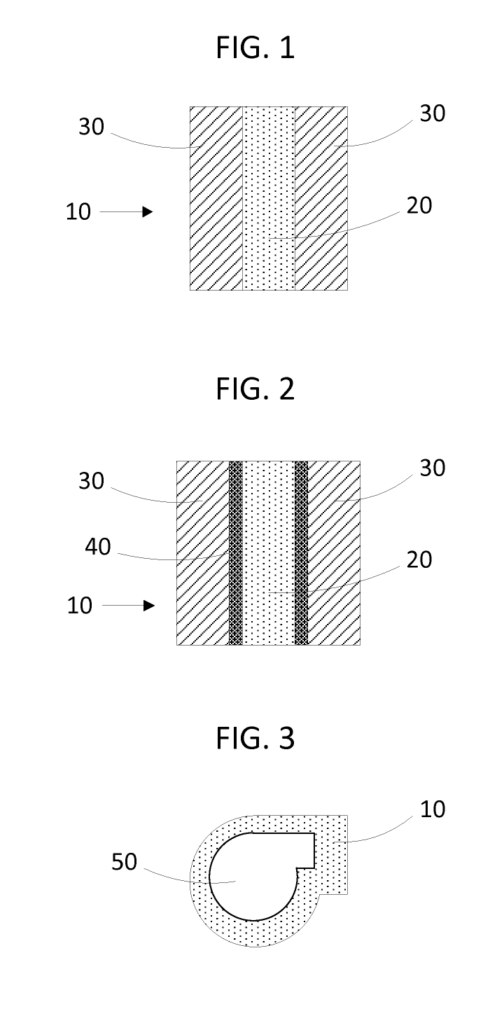

In one embodiment, as shown in FIG. 1, the invention comprises a multi-layered composite 10 operable to absorb neutrons. In one embodiment, an at least three layer composite 10 is provided having an internal layer 20 comprising a neutron absorbing material and two external layers 30 disposed on opposing sides of the internal layer as shown. In one embodiment, the neutron absorbing material comprises a boron containing composition. In one embodiment, the boron containing layer 20 is a sintered boron carbide layer. In another embodiment, the boron carbide layer has a density of about 93% or greater.

Boron carbide is an extremely hard material and useful as a radiation shield material for nuclear reactor facilities because of the material's ability to absorb neutrons without forming long lived radio-nuclides. Accordingly, the material is amenable to pulverization to form a power which may be sintered or fired into various useful shapes. In general, the sintering process involves using a powdered form of boron which is placed in a mold and fired (i.e. heated) to a high temperature below the melting point of the material. This process results in densification of the material which fuses the particles together thereby creating a solid monolithic piece of material having a shape conforming to the shape of the mold.

In another embodiment, the external layers 30 of the at least three layered composite 10 having a neutron absorbing layer 20 are each made of the same material. The external layers 30 can comprise metal or ceramic materials. In one embodiment, the external layers 30 comprise aluminum or stainless steel. In another embodiment, the thickness of the external layers 30 can vary widely depending upon what element within the containment chamber is being protected. In one embodiment, the thickness of the external layers 30 is between about 5 mils to 250 mils. In one embodiment, the external layers 30 are stainless steel having a thickness of about 40-60 mils.

In another embodiment, the at least three layer composite 10 has one ceramic external layer 30 and one metallic external layer 30.

In one embodiment, the at least three layer composite 10 provides protection to equipment components 50 outside the nuclear reactor core (see, e.g. FIG. 3 showing a pump). In some embodiments these components 50 comprise water cooling system components including for example, but not limited to recirculation pumps, jet pumps, piping, valves, fasteners. Any other types of component or structure susceptible to radiation damage may be protected as well by the multi-layered composite disclosed herein. In another embodiment, the composites 10 of this invention can be located or disposed on or located proximate to the surface of the various containment vessels housing the reactor core (e.g. reactor pressure vessel, core shroud, etc.) as well as equipment within the containment chamber.

One advantage of the composites 10 of this invention is that the boron containing layer 20 and outer ceramic layers 30 are flexible before firing to harden and can be formed into any shape to fit the desired dimensions of a component 50 to be protected (see, e.g. FIG. 3). This allows for fabrication of the protected component 50 in a manufacturing facility or on-site. Embodiments of the present disclosure therefore provides a conformal composite covering configured to complement and closely conform to the largest extent practicable the configuration of the component or equipment to which the covering will be applied.

In another embodiment, the fabricated composite 10 of the invention can be fitted and attached to the component 50 to be protected on-site. When the external layers 30 are metal, heat welding can be employed to fully assemble the protection (i.e. protective composite covering) to the component. For example, if the boron containing layer is fully encapsulated within metal external layers, then heat welding can be used to join the ends of the prefabricated composite around the component 50 to be protected. In cases where the weld itself needs protection due to stress cracking concerns, another composite layer 10 can be applied over the first weld so that the boron layer 20 covers the first weld and protects the weld from radiation damage.

In another embodiment, the composite 10 can be located on the concrete surface of a containment chamber or vessel. In one embodiment, the composite 10 applied to a concrete surface has at least one ceramic external surface or layer. In one embodiment, the composite having a ceramic layer 30 surface is fired when it is in contact with the concrete surface.

In yet another embodiment, the composite 10 comprising a boron containing layer 20 further comprises at least one additional layer 40 located adjacent the boron layer and an external layer (see FIG. 2). In one embodiment, this additional at least one layer 40 comprises a self-healing material. The self-healing layer 40 may be disposed on a single side or both sides of the boron layer 20 between the external layers 30 and inner boron layer.

An additional problem encountered in nuclear reactors involves the core shroud. The core shroud in boiling water reactors (BWR) supports and locates the reactor core within the reactor pressure vessel (RPV), and forms the flow partition for the reactor core coolant. It is constructed of a number of stainless steel circular rings and cylindrical rolled plate sections, joined at their ends with circumferential welds. Such constructions are well known in the art. The welding introduces residual stresses in the weld heat affected zones. It additionally locally sensitizes the stainless steel, which depletes the grain structure of chromium and reduces corrosion resistance. These factors, combined with the BWR reactor coolant environment, make the weld heat affected zones susceptible to intergranular stress corrosion cracking (IGSCC), observed in many BWR shrouds. The cracking impairs the structural integrity of the shroud. Particularly, lateral seismic loading or loss of coolant accident (LOCA) conditions could cause relative displacements at cracked weld locations which could produce large core flow leakage and misalignment of the core that could prevent control rod insertion and safe shutdown. Because the loss of power production during outages is a significant cost, it is desirable to minimize the required duration of any repair operations, particularly, shroud weld repair operations. There are a large number of patents describing physical ways to stabilize the reactor shroud to maintain alignment when weld damage occurs and repairs are needed.

In one embodiment, an at least three layered composite 10 of the invention is fabricated so that it contacts the inside surface of the stainless steel shroud and provides protection to the shroud welds thereby enhancing shroud weld life time. The composite 10 may be attached to the inside surface by any suitable method used in the art. In one embodiment, the at least three layer composite 10 is of unitary construction. In another embodiment, the at least three layer composite 10 is located such that only selected weld areas of the shroud are protected.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that various embodiments according to the present disclosure may be configured in other forms, structures, arrangements, proportions, sizes, and with other elements, materials, and components, without departing from the spirit or essential characteristics thereof. In addition, numerous variations in the exemplary methods and processes described herein may be made without departing from the present disclosure. The presently disclosed embodiments are therefore to be considered in all respects as illustrative and not restrictive, the scope of the claimed invention being defined by the appended claims and equivalents thereof, and not limited to the foregoing description or embodiments.

What is claimed is:

1. A radiation absorbing system for a nuclear reactor having a containment chamber and a reactor pressure vessel therein containing a fuel rod core, the system comprising:
a multi-layer composite comprising an internal layer including a neutron absorbing material and an external layer disposed on opposing sides of the internal layer,
wherein the composite is disposed proximate to a surface of an equipment component within the containment chamber of the nuclear reactor and is operable to protect the component from radiation damage.

2. The composite of claim 1, wherein the components are outside the reactor pressure vessel in the containment chamber.

3. The composite of claim 2, wherein the equipment component is selected from the group consisting of a circulating pump, jet pump, piping, valves, and fasteners.

4. The composite of claim 1, wherein the internal layer comprises a boron containing composition.

5. The composite of claim 4, wherein the boron containing composition comprises a sintered boron carbide composition.

6. The composite of claim 5, wherein, the sintered boron carbide layer has a density of about 93% or greater.

7. The composite of claim 1, wherein the external layers are each made of the same material as the other.

8. The composite of claim 7, wherein the external layers comprise metal or ceramic materials.

9. The composite of claim 8, wherein the metal material is aluminum or stainless steel.

10. The composite of claim 1, wherein the thickness of each external layer is essentially the same.

11. The composite of claim 1, wherein each external layer has a thickness between about 5 mils and 250 mils.

12. The composite of claim 1, wherein the external layers comprise stainless steel having a thickness of between 20 mils to 80 mils.

13. The composite of claim 1, wherein the composite comprises one ceramic external layer and one metallic external layer.

14. The composite of claim 1, wherein the composite is located on at least a portion of a surface of the containment chamber.

15. The composite of claim 14, wherein the containment chambers surface comprises concrete.

16. The composite of claim 1, wherein the composite is fabricated to conform in configuration to a shape of the equipment component to be protected.

17. The composite of claim 1 , wherein the composite is operably disposed within the reactor pressure vessel and protects welds of a reactor shroud surrounding the fuel rod core.

18. The composite of claim 1, further comprising at least one self-healing layer.

19. A radiation absorbing system for a nuclear reactor having a containment chamber and a reactor pressure vessel therein containing a fuel rod core, the system comprising:
a multi-layer composite comprising an internal layer including a neutron absorbing material and an outer layer disposed on opposing sides of the internal layer;
the internal layer comprising a boron containing composition;
the external layers each comprising one of a metal or ceramic material;
wherein the composite is disposed proximate to a surface of an equipment component within the containment chamber of the nuclear reactor and is operable to protect the component from radiation damage.

20. A neutron absorbing system for a nuclear reactor having a containment chamber, a reactor pressure vessel therein containing a fuel rod core, and at least one equipment component disposed in the containment chamber, the system comprising:
a multi-layer composite comprising an at least three layer structure including an internal layer including a neutron absorbing material and an outer layer disposed on opposing sides of the internal layer;
the internal layer comprising a boron containing composition;
the external layers each comprising one of a metal or ceramic material;
wherein the equipment component has a surface having a shape and the composite is disposed proximate to the surface of the equipment component; and
wherein the composite has a configuration conforming to the shape of the surface of the equipment component and is operable to protect the component from radiation damage.
